(19) United States
(12) Patent Application Publication
(10) Pub. No.: US 2018/0372649 A1
(43) Pub. Date: Dec. 27, 2018

(54) 3D INSPECTION SYSTEM

(71) Applicant: Magna Exteriors Inc., Concord (CA)

(72) Inventors: David Fernandez Ortiz, Colon Queretaro (MX); Luis Landa Garcia, Colon Queretaro (MX); Salvador Salazar, Guanajuato (MX)

(21) Appl. No.: 16/017,306

(22) Filed: Jun. 25, 2018

Related U.S. Application Data
(60) Provisional application No. 62/524,160, filed on Jun. 23, 2017.

(51) Int. Cl. G01N 21/88

(52) U.S. Cl. CPC G01N 21/8806

(57) ABSTRACT

A three dimensional inspection system including a 3D scanner device and robotic device for scanning an assembly, such as an automotive assembly, loaded to a nest. Due to the automatic inspection system, the equipment is able to detect and alert an operator if any component of the assembly is missing and that the components are in the correct position.

### CROSS REFERENCE TO RELATED APPLICATIONS

This application claims the benefit of U.S. Provisional Application No. 62/524,160, filed Jun. 23, 2017. The disclosures of the above application is incorporated herein by reference.

### FIELD OF THE INVENTION

The present invention relates to a component detection and review system and method for same.

### BACKGROUND OF THE INVENTION

The automotive industry sets delivery control standards for assembled components. There is potential risk in the automotive assembly of suppliers shipping automotive assemblies, such as front and rear fascias, with missing parts, wrongly assembled components, wrong components or components in the wrong position, etc. to the final customer. Detection of issues in the first place and human error further contribute to these problems.

Due to volumes and the number of components of automotive assemblies (e.g., front and rear fascias, sac panels, rockers, etc) there is a need to develop a new vision system to ensure the quantity of components in each front and rear fascia.

A vision system by cameras has been contemplated. There was developed a new vision station having the inspection with the fascia in an “A” surface down position in order to help the cameras to make the validation of the components. After some trials with those cameras, it was determined that the vision system through cameras had some restrictions with the components used in the bumpers. The vision system was not able to repeat the inspection point.

Accordingly, there is a need in the industry for a more effective automated inspection system to detect an issue and alert an operator.

### SUMMARY OF THE INVENTION

The present invention generally relates to a three dimensional (3D) inspection system incorporating a 3D scanner. The present invention is particularly suitable for parts having complex geometry, which are difficult to manually review and also which have a higher risk for missing or incorrectly installed components.

The inventive system helps the operator to easily detect if any component is missing, through the 3D scanner moved by a robot. The robot moves the scanner according to the component, e.g., fascia, pattern positioning the scanner in different angles to get the best inspection point. The operator's panel (HMI) displays the whole fascia layout, which allows the operator to identify the wrong, missing or misassembled component. This 3D inspection system is incorporated into predetermined inspection, and quality assurance and approval procedures, depending on the application, for a specified period of time or in perpetuity to determine and maintain quality of final assemblies shipped to the final customer. In addition, a copy of the 3D inspection (e.g., 3D images as the result of the inspection) is stored on a server. If any customer complaint is made due to missing components, this will work as evidence to prove that the fascia or other part was shipped fully assembled.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a 3D inspection system, in accordance with an embodiment of the present invention;

FIG. 2 is a front elevation view of FIG. 1;

FIG. 3 is a perspective view of a nest of the 3D inspection system holding an automotive assembly, according to the present invention;

FIG. 4 is an enlarged bottom perspective view of part of the nest and automotive assembly of FIG. 3, according to the present invention;

FIG. 5 is a front elevation view of FIG. 3;

FIG. 6 is a perspective view of the 3D inspection system with a nest for another automotive assembly, in accordance with an embodiment of the present invention;

FIG. 7 is a top perspective view of FIG. 6; and,

FIG. 8 is a front elevation view of FIG. 6.

### DETAILED DESCRIPTION OF THE PREFERRED EMBODIMENTS

The following description of the preferred embodiment(s) is merely exemplary in nature and is in no way intended to limit the invention, its application, or uses.

Due to the importance of ensuring the quantity and the correct components in the final assembled fascia, a strong inspection system is required that is able to detect the presence and position of the whole assembly of components. In the present invention it was found that the best equipment to review all the components used based on their complex geometry is use of a 3D scanner.

Referring to the Figures generally, the present invention is directed to a 3D inspection system incorporating a 3D scanner. The inspection capability of this system covers the following components: U nuts, rivets, push pins presence in different areas, the differences between the front lower grilles according to the version required, rear fog lamps vs rear reflex, differences between energy absorber as the version required, tow eye door presence, trailer tow bezel kit according to version, valance hitch and tabs from upper and lower assembly. It is understood that any other predetermined component of any kind, and predetermined assembly requirement of any kind, can be set for inspection depending on the application without departure of the scope of the present invention.

This system helps the operator to easily detect if any component is missing, through the 3D scanner moved by a robot, the robot moves the scanner according to the fascia pattern, positioning the scanner in different angles to get the best inspection point. An operator's panel (HMI) displays the whole fascia layout, which allows the operator to identify the wrong, missing or misassembled component. This 3D inspection system is used as part of quality control. A copy of the 3D inspection (images 3D as the result of the inspection) is stored on the server(s), alternatively, on flash drive(s). If any customer complaint is made due to missing components, this will work as evidence to prove that the fascia was shipped fully assembled.

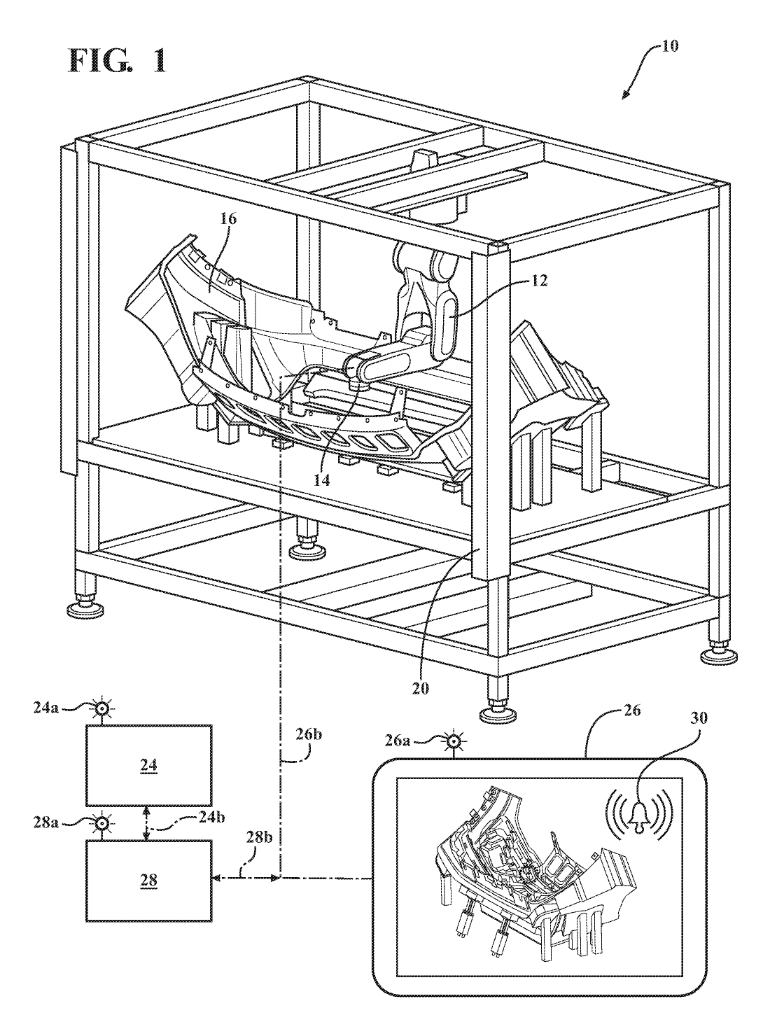

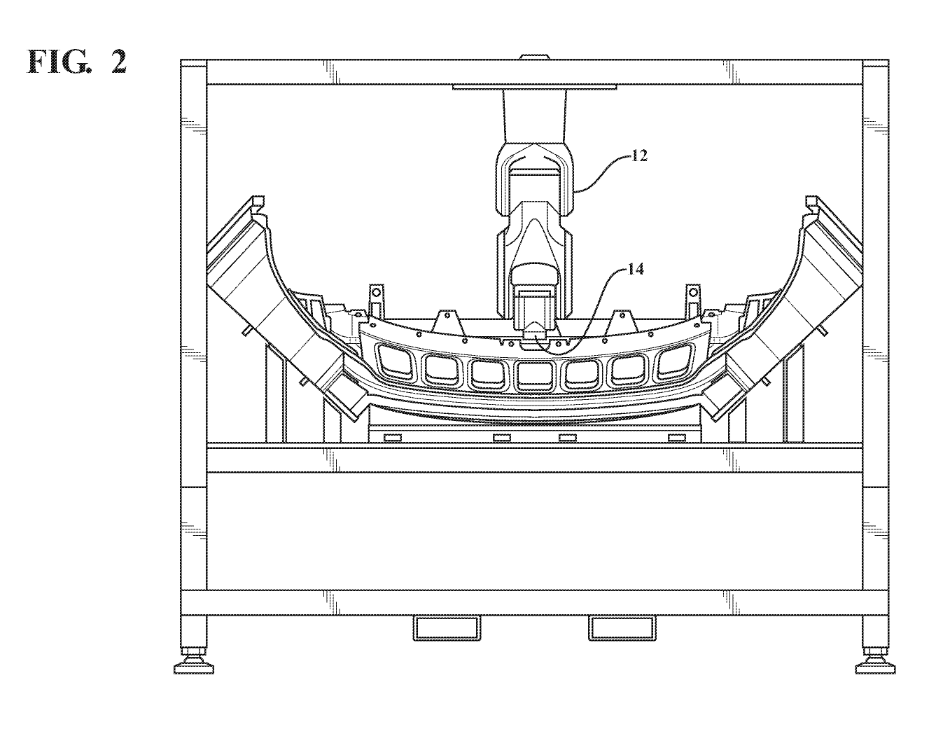

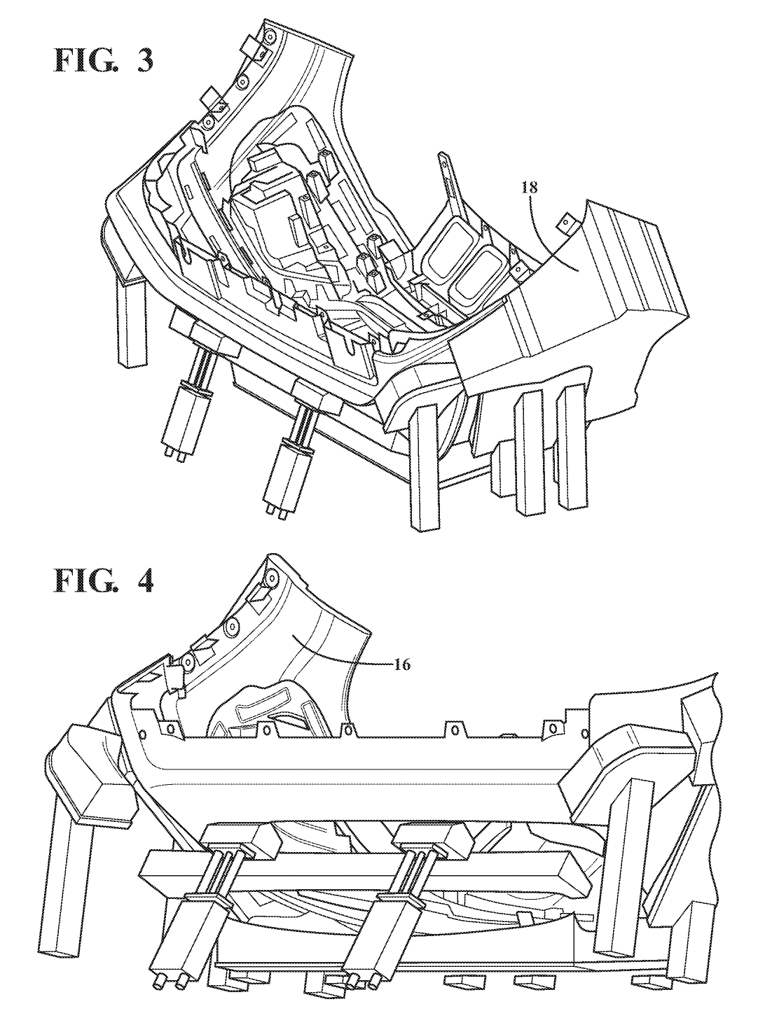

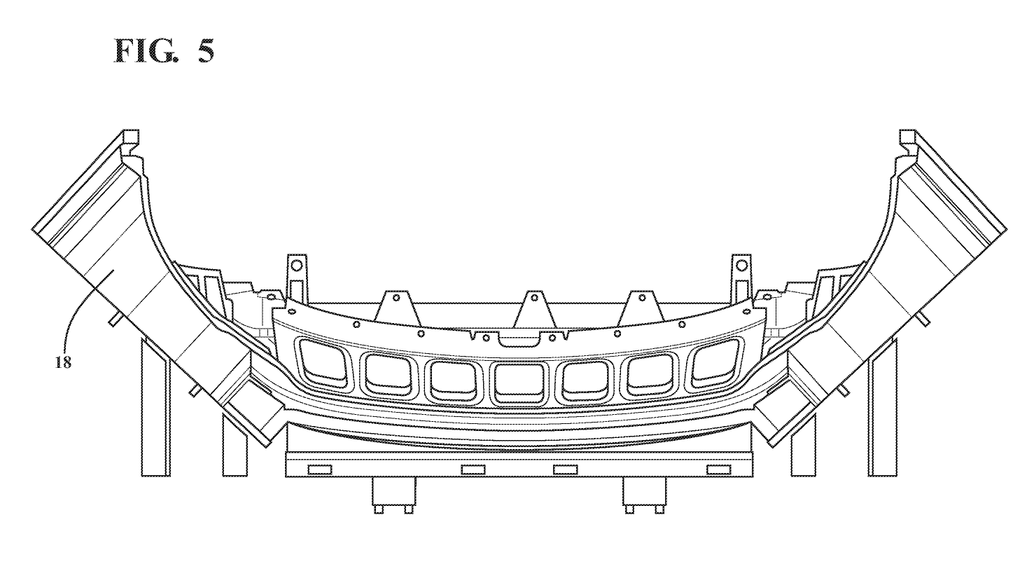

Referring more particularly to FIGS. 1-5, the 3D inspection system shown generally at 10 includes a robot 12 incorporating a 3D scanner 14, according to an embodiment of the present invention. The system is suitable to inspect the presence and position of the components in the final assembly 16, e.g., in the final assembled front fascia. At least one nest 18 is provided to support the assembly 16. Preferably, the nest 18 is a urethane nest to prevent damage to the painted or more touchy surface, e.g., TPO, when the fascia 16 is properly seated. The nest 18 also has a vacuum system to keep the repeatability of nesting of fascias 16.

A programmable logic controller (PLC) 24 is also provided. In addition, a human machine interface (HMI) 26 is provided. These are adaptable for wired (thrust wires 24b, 26b and 28b) or wireless communication (antennas 24a, 26a and 28a), e.g., with each other, the scanner 14 or server 28, depending on the application. FIG. 1 depicts an enlarged view of a portion of an HMI 26 showing the back of assembly 16 being inspected. An alert 30 is illustrated resulting from a missing fastener. The alert is audible and/or visual for the operator.

Optionally, protective moldings are mounted to the entry framing of the cell to prevent damage from any contact with the frame during loading of the part 16 to the nest 18.

The 3D scanner 14 is connected to the robot 12, e.g., articulating robotic arm, and the robot 12 moves the 3D scanner 14 over predetermined areas of the fascia 16, typically, over all exposed services of the fascia, preferably, over the whole fascia 16. The robot 12 is programmable for moving and scanning, via the 3D scanner 14, from predetermined distances over the entire part 16. A particularly preferred robot 14 for use in the present invention is a MZ03EL available from Nachi Robotic Systems, in Novi, Mich. The 3D inspection provides image analysis through a red visible laser light, according to an embodiment of the present invention. A preferred laser class is 2N (IEC 60825-1:2007). In general, independent measurements of the contrast of the colors and objects is processed. A particularly preferred 3D scanner 14 for use in the present invention is IVC-3D11111 available from SICK Sensor Intelligence in Minneapolis, Minn. By way of non-limiting example, the processor is at least about 800 MHz, scane/frame rate is at least about 5,000 3D profiles per second, memory is at least about 128 MB RAM, 16 MB flash drive, height resolution is at least about 0.2 mm, and 3D profile resolution is at least about 2,048 points.

The present invention is particularly suitable for parts having complex geometry, which were previously difficult to manually review and had a higher risk for missing or incorrectly installed components. The present invention assists an operator in easily detecting any component missing or installed incorrectly. The present invention also logs or otherwise stores data suitable for quality inspection audits or inquiries for a predetermined period of time.

The inventive system helps the operator to easily detect if any component is missing, through the 3D scanner moved by a robot. The robot moves the scanner according to the component, e.g., fascia pattern, positioning the scanner in different angles to get the best inspection point. The operator's panel (HMI) 26 displays the whole fascia layout, which allows the operator to identify the wrong, missing or misassembled component. This 3D inspection system is incorporated into predetermined inspection, and quality assurance and approval procedures, depending on the application, for a specified period of time or in perpetuity to determine and maintain quality of final assemblies shipped to the final customer. In addition, a copy of the 3D inspection (e.g., 3D images as the result of the inspection) is storable on a server. If any customer complaint is made due to missing components, this will work as evidence to prove that the fascia or other part was shipped fully assembled.

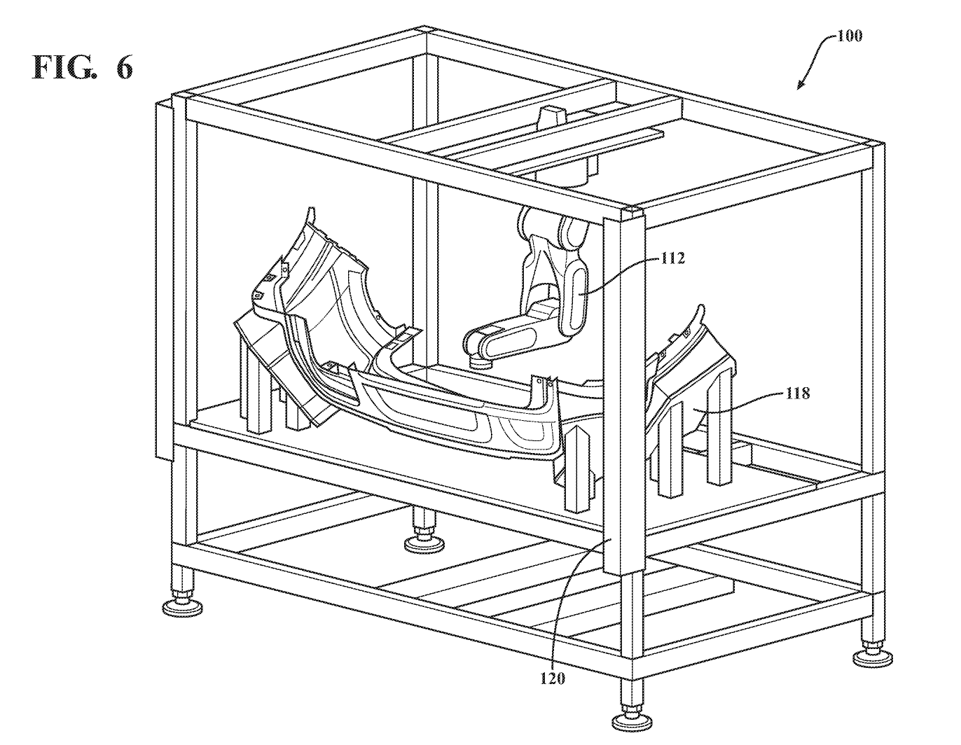

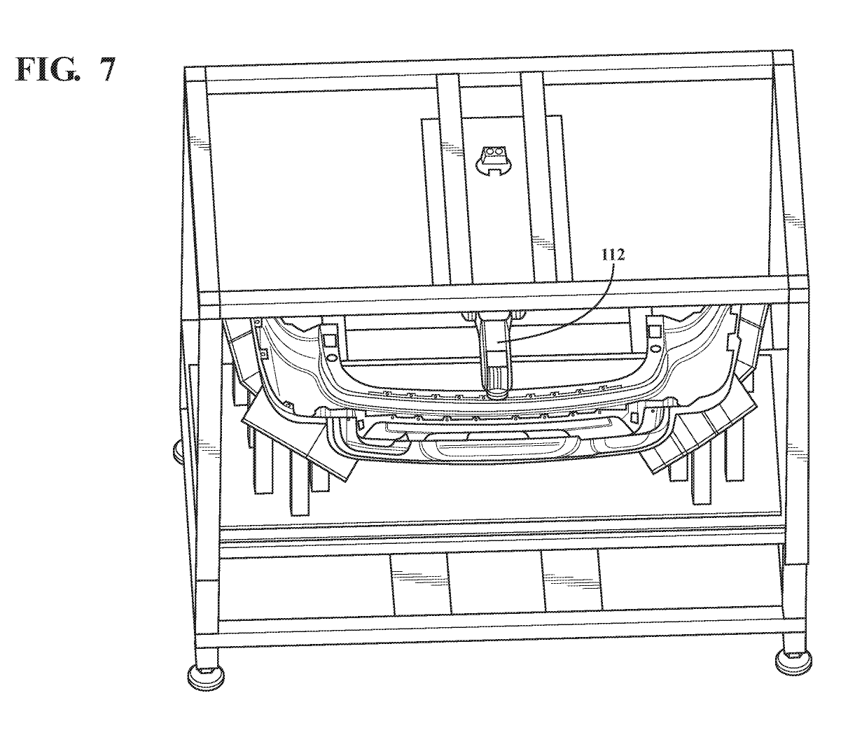

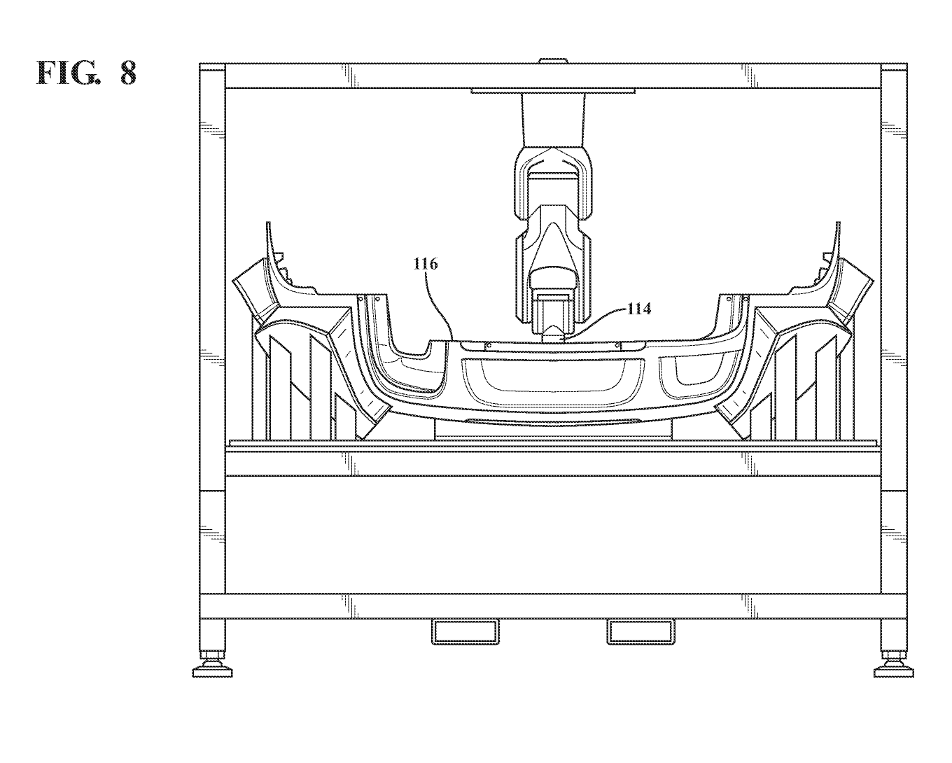

Referring more particularly to FIGS. 6-8, there is depicted a 3D inspection system shown generally at 100, identical to FIGS. 1-5, except that it is adapted for another automotive component being scanned, e.g., rear fascia. The system 100 includes a robot 112 incorporating a 3D scanner 114, according to an embodiment of the present invention. Optionally, protective moldings 120 are provided to the units frame. The system is suitable to inspect the presence and position of the components in the final assembly 116, e.g., in the final assembled rear fascia. At least one nest 118 is provided to support the assembly 116. The system 100 is identical as described previously as to the system 10. The 3D inspection system 100 also incorporates the programmable logic controller (PLC) 24, human machine interface (HMI) 26 and server 28 (see FIG. 1), as described previously.

By including details about where and what fasteners or other parts are missing or missassembled, an operator can then correct the condition and then run the inspection again.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A three dimensional (3D) inspection system, comprising:
a 3D scanner device;
a robotic device operable to move the 3D scanner over a predetermined component being inspected;
a programmable logic controller operable to control movement and scanning of the 3D scanner; and
a human machine interface for monitoring or being alerted to inspection results relayed from the 3D scanner analysis.

2. The 3D inspection system of claim 1, wherein the 3D inspection provides image analysis through a red visible laser light.

3. The 3D inspection system of claim 1, wherein the 3D scanner device laser class is 2N (IEC 60825-1:2007).

4. The 3D inspection system of claim 1, wherein the 3D scanner device has a scane/frame rate of at least about 5,000 3D profiles per second.

5. The 3D inspection system of claim 1, wherein the 3D scanner device has a 3D resolution of at least about 2,048 points.

6. The 3D inspection system of claim 1, further comprising a nest to support the component.

7. The 3D inspection system of claim 1, further comprising a urethane nest to support the component and prevent damage to the component.

8. The 3D inspection system of claim 1, further comprising a nest to receive and hold the component during inspection, wherein the nest incorporates a vacuum system to ensure repeatability of positioning of the components into the nest.

9. The 3D inspection system of claim 1, wherein the component is a front fascia assembly or a rear fascia assembly.

10. The 3D inspection system of claim 1, further comprising at least one server, wherein inspection result data is stored for each component.

11. The 3D inspection system of claim 10, wherein the inspection result data is at least one image of each component.

12. The 3D inspection system of claim 10, wherein the 3D inspection system incorporates wireless communication between components and the server.

13. The 3D inspection system of claim 1, wherein the 3D scanner device detects any missing or missassembled parts of the component.

14. The 3D inspection system of claim 1, wherein the alert is visual and/or audible.

15. A method of inspecting an automotive assembly with a 3D inspection system, comprising:
providing an automotive assembly;
providing a urethane nest;
providing a user interface device;
providing a 3D scanner device connected to an articulatable robotic arm for automatically moving the 3D scanner device as desired, wherein the 3D scanner is pre-programmed for inspecting the automotive assembly for missing or incorrecting assembled parts or other predetermined conditions;
loading the automotive assembly into the urethane nest;
inspecting predetermined areas of the automotive assembly for missing or incorrecting assembled parts using the 3D scanner;
sending an alert to the user interface device when the 3D scanner detects missing or incorrecting assembled parts.

16. The method of inspecting an automotive assembly with a 3D inspection system, of claim 15, further comprising providing at least on server and storing inspection data on the at least one server for a predetermined time for each automotive assembly inspected.

17. The method of inspecting an automotive assembly with a 3D inspection system, of claim 15, further comprising generating inspection specific to the automotive assembly when desired.

18. The method of inspecting an automotive assembly with a 3D inspection system, of claim 15, further comprising storing at least one image of the automotive assembly as inspected.

19. The method of inspecting an automotive assembly with a 3D inspection system, of claim 15, wherein the automotive assembly is a front fascia assembly or a rear fascia assembly finished product prior to shipping to a customer.

20. A three dimensional inspection system of an automotive component, comprising:
an articulating robotic arm;
a 3D scanner device mounted to the end of the robotic arm, said 3D scanner operable to provide image analysis through a red visible laser light;
an interchangeable urethane nest shaped for holding a specific automotive assembly thereon;
a programmable logic controller operable to control inspection of the automotive assembly on the nest;
a human machine interface operable to alert an operator to inspection results, wherein the inspection results include details about location and number of any missing fastener(s), missassembled fastener(s), missassembled part(s), or a positive result that the automotive assembly passes inspection with no missing or misassembled fasteners/parts.
